(19) United States
(12) Patent Application Publication
(10) Pub. No.: US 2011/0141768 A1
(43) Pub. Date: Jun. 16, 2011

(54) HIGH BRIGHTNESS LIGHT PANEL

(76) Inventors: Kihyun JEON, Kyoungsan-City (KR); Kiwon HAN, Kyoungsan-City (KR); Cheolyong CHOE, Kyoungsan-City (KR)

(21) Appl. No.: 12/953,914

(22) Filed: Nov. 24, 2010

(30) Foreign Application Priority Data
Dec. 10, 2009 (KR) 10-2009-0122573
Dec. 10, 2009 (KR) 10-2009-0122576
Dec. 10, 2009 (KR) 10-2009-0122578

(51) Int. Cl. F21V 7/04; F21V 29/00

(52) U.S. Cl. 362/614; 362/294

(57) ABSTRACT

A high brightness light panel is provided. The light panel includes a fixing frame, a light reflective plate, a lighting unit, and an external electrode holder. The fixing frame forms an outer frame. The light reflective plate is installed in the fixing frame. The lighting unit has at least one or more External Electrode Fluorescent Lamps (EEFLs) spaced apart and arranged in parallel and forming one unit lamp group. The external electrode holder is sliding-inserted and installed along a length direction of the fixing frame, and has sockets installed therein and fixing-supporting external electrodes of the EEFLs.

### CROSS REFERENCE

This application claims foreign priority under Paris Convention and 35 U.S.C. §119 to Korean Patent Application Nos. 10-2009-0122573 filed Dec. 10, 2009, 10-2009-0122576 filed Dec. 10, 2009, and 10-2009-0122576 filed Dec. 10, 2009, respectively with the Korean Intellectual Property Office.

### BACKGROUND OF THE INVENTION

1. Field of the Invention

The present invention relates to a high brightness light panel. More particularly, the present invention relates to a high brightness light panel for providing a unit lamp group in which a plurality of External Electrode Fluorescent Lamps (EEFLs) are spaced apart and arranged in parallel and also connecting a plurality of the unit lamp groups without a shadow spot, thereby not only being capable of modularizing EEFLs of a high brightness and a stable operation characteristic and easily realizing a large-size light panel but also being capable of improving product reliability through uniform brightness security.

2. Description of the Related Art

Generally, unlike a general fluorescent lamp, an EEFL has an electrode installed outside. Compared to a Cold Cathode Fluorescent Lamp (CCFL), the EEFL has an excellent brightness of 60% or more. Therefore, the FEEL is advantageously applicable to applications such as a TeleVision (TV), a Thin Film Transistor (TFT) Liquid Crystal Display (LCD), etc. needing a high brightness. Also, because the EEFL can be manufactured to have a relatively small outer diameter, the slimness of a lighting device is easy.

The EEFL allows a flow of electric current in the external electrode and induces electric discharge, thereby emitting light. At this time, the EEFL can minimize a current deviation between the EEFLs through in-parallel connection, thereby obtaining a uniform brightness.

The conventional light panel is an individual driving type light panel using a fluorescent light and a CCFL. The recent attempt is being made to manufacture a light panel having more definite and uniform brightness using the EEFL of the high brightness and excellent operation characteristic as a lighting device of the light panel.

In general, the conventional light panel installs a plurality of EEFLs of outer diameters of about 8 mm in a fixing frame, and connects external electrodes of the respective EEFLs in parallel with each other by a power line. And, the light panel installs a plurality of lamp holders standing up on a base plate installed in rear of the light panel, combines the lamp holders with a light emitting unit of the EEFL, and holds the EEFL.

However, the conventional light panel has the problems as follows.

The first is that, because the plurality of lamp holders are combined with the light emitting units to hold one EEFL, assemblability is deteriorated due to an increase of the number of parts, and the lamp holder interrupts light emission of the light emitting unit. The second is that, because individual sockets are each combined with the external electrodes of the respective EEFLs and these sockets are connected through the power line, installation and uninstallation of the EEFL is difficult, and the extensibility for large-sizing of the light panel is remarkably deteriorated. The third is that, because of an increase of manhour of each EEFL, workability decreases as well as a manufacturing cost increases.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to realize a large-area light panel of a high definite and a high brightness using an External Electrode Fluorescent Lamp (EEFL) of a high brightness and a stable operation characteristic.

Another aspect of exemplary embodiments of the present invention is to provide an internal/external electrode holder of an excellent insulation characteristic, thereby removing a shadow spot as well as maintaining a uniform brightness throughout the light panel surface.

A further aspect of exemplary embodiments of the present invention is to modularize and group a plurality of EEFLs as a plurality of unit lamp groups through an integrated internal/external electrode holder connecting the plurality of EEFLs conductible with each other, thereby making installation and uninstallation easy.

A still another aspect of exemplary embodiments of the present invention is to install a heat sink, thereby preventing a safety accident resulting from a high heat or a high voltage, preventing a work failure, and improving product reliability.

According to one aspect of the present invention, a high brightness light panel is provided. The light panel includes a fixing frame, a light reflective plate, a lighting unit, and an external electrode holder. The fixing frame forms an outer frame. The light reflective plate is installed in the fixing frame. The lighting unit has at least one or more External Electrode Fluorescent Lamps (EEFLs) spaced apart and arranged in parallel and forming one unit lamp group. The external electrode holder is sliding-inserted and installed along a length direction of the fixing frame, and has sockets installed therein and fixing-supporting external electrodes of the EEFLs such that the external electrodes can be coupled in parallel to be conductible with each other.

The lighting unit has a plurality of the unit lamp groups connected and installed. A connection part connects the unit lamp groups to each other and is arranged such that the EEFLs overlap with each other at their ends. The connection part has a connection means for installing and coupling the sockets to the external electrodes of the EEFLs.

### BRIEF DESCRIPTION OF THE DRAWINGS

The above and other objects, features and advantages of the present invention will become more apparent from the following detailed description when taken in conjunction with the accompanying drawings in which:

FIG. 1 is a plane diagram illustrating a high brightness light panel according to the present invention;

FIG. 2 is a schematic plane diagram illustrating a lighting unit of the light panel of FIG. 1;

FIG. 3 is an exploded perspective diagram illustrating an external electrode holder according to the present invention;

FIG. 4 is a sectional diagram illustrating a fixing frame according to the present invention;

FIG. 5 is a plane diagram illustrating a high brightness light panel according to another exemplary embodiment of the present invention;

FIG. 6 is a schematic plane diagram illustrating a lighting unit of the light panel of FIG. 5;

FIG. 7 is a cross-sectional diagram illustrating the light panel of FIG. 5;

FIG. 8 is an exploded perspective diagram illustrating an internal electrode holder of the light panel of FIG. 5;

FIG. 9 is an enlarged diagram illustrating ‘A’ of FIG. 7; and

FIG. 10 is a sectional diagram illustrating an internal electrode holder according to another exemplary embodiment of the present invention.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

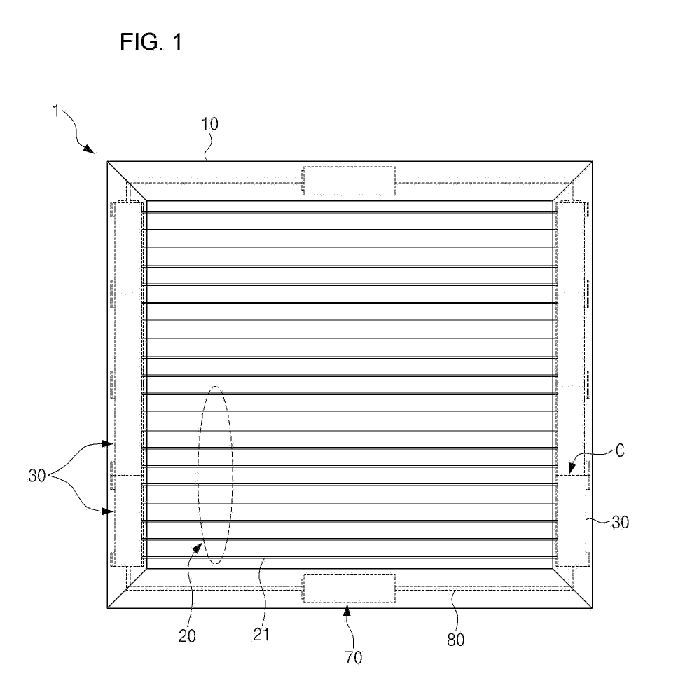

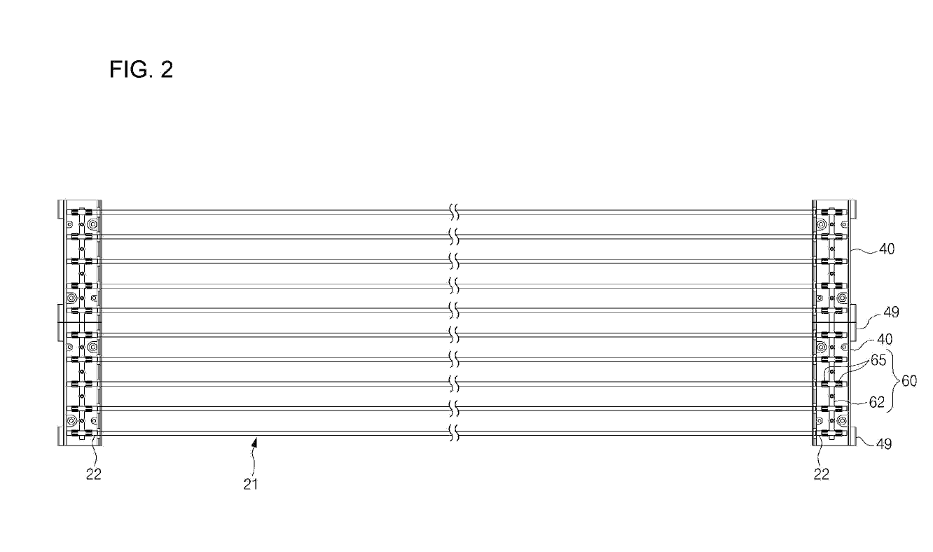

FIG. 1 is a plane diagram illustrating a high brightness light panel according to an exemplary embodiment of the present invention. FIG. 2 is a schematic plane diagram illustrating a lighting unit of the light panel according to the present invention.

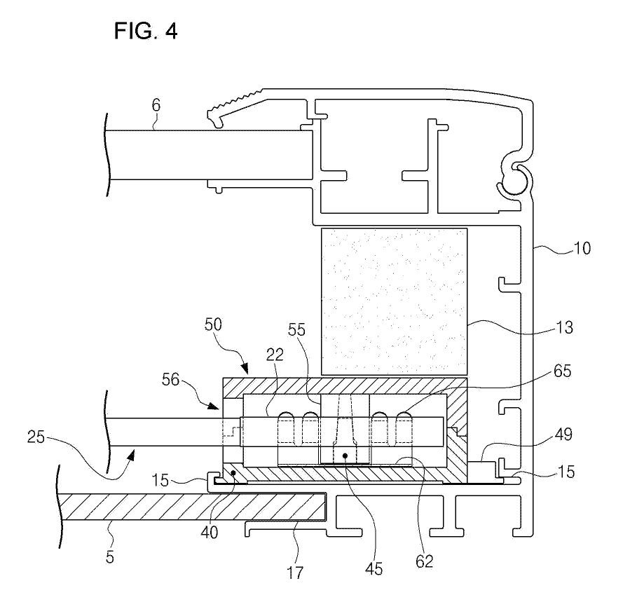

As illustrated, the light panel 1 of the present invention includes a fixing frame 10, a light reflective plate 5 (shown in FIG. 4), a lighting unit 20, and an external electrode holder 30.

The fixing frame 10, a rectangular outer frame formed for billboard (not shown) installation, can be variously formed according to a size and shape of a billboard. A plurality of frames are formed inside the fixing frame 10 such that the light reflective plate 5, a cover plate 6, and the external electrode holder 30 described below can be installed.

The fixing frame 10 can be formed of material of plastic, metal, etc., but is desirably formed of aluminum of relative low weight.

The light reflective plate 5 is installed in a rear part of the fixing frame 10 and reflects light of an External Electrode Fluorescent Lamp (EEFL) 21 only to the front. As illustrated in FIG. 4, the light reflective plate 5 is formed in a plate shape of a predetermined thickness and, desirably, has a reflective coating or reflective sheet in its front to maximize light reflection.

The lighting unit 20 is, as illustrated in FIG. 1, installed in front of the light reflective plate 5 installed in the fixing frame 10 and plays a role of lighting the billboard. The lighting unit 20 includes a plurality of EEFLs 21.

The lighting unit 20 forms one unit lamp group in which at least one or more EEFLs 21 are spaced a predetermined distance apart and arranged. The number of the unit lamp groups or an arrangement interval or the number of the EEFLs 21 may be various according to a size or shape of the light panel 1.

In general, the EEFL 21, which uses a high frequency high voltage, installs an electrode outside, and emits light by allowing a flow of electric current in the external electrode and inducing electric discharge. As illustrated in FIG. 1, the EEFLs 21 connect with each other in parallel and minimize a current deviation between the EEFLs 21 and thus, can obtain a uniform brightness for the whole lighting area.

Also, because the EEFL 21 has a relatively small outer diameter, has an excellent operation characteristic, and obtains a high brightness, the EEFL 21 desirably uses 3Φ, 3.4Φ, 4Φ, or 5Φ (unit: mm) for the sake of slimness of the light panel 1.

The external electrode holder 30 is inserted and installed inside the fixing frame 10, and holds and supports an external electrode 22 of the EEFL 21. A socket 60 is provided inside the external electrode holder 30, and is coupled to the external electrode 22.

The socket 60 has a plurality of terminals 65 for parallel-connecting the external electrodes 22 of the plurality of EEFLs 21 conductible with each other, thereby fixing the EEFL 21.

As illustrated in FIG. 2, the socket 60 can be provided to modularize ten EEFLs 21 as one unit lamp group by arranging ten terminals 65 in parallel to couple ten EEFLs 21.

Also, generally, up to the maximum twenty EEFLs 21 can connect to one stabilizer 70 and thus, the socket 60 may be provided to modularize the twenty EEFLs 21 as one unit lamp group.

At this time, the external electrode holder 30 can be coupled in plural to one socket 60.

In case that there is a need to install EEFLs 21 of the number exceeding a capacity of the stabilizer 70 due to the large size of the billboard, the unit lamp groups forming the above modules may be arranged up/down and applicable to the large-size light panel 1.

At this time, the stabilizer 70 can be insertion-installed in upper and lower parts of the fixing frame 10, and connects with the socket 60 by a power line 80.

Also, because of a characteristic of the EEFL 21 using the high frequency high voltage, an insulation tube (not shown) is desirably out-inserted to the power line 80 and minimizes the influence of an electric field.

A buffer part 13 (shown in FIG. 4) such as elastic rubber material, PolyEthylene (PE) foam, and the like can be installed between a top surface of the stabilizer 70 and an inner frame of the fixing frame 10 so as to prevent a vibration of the stabilizer 70.

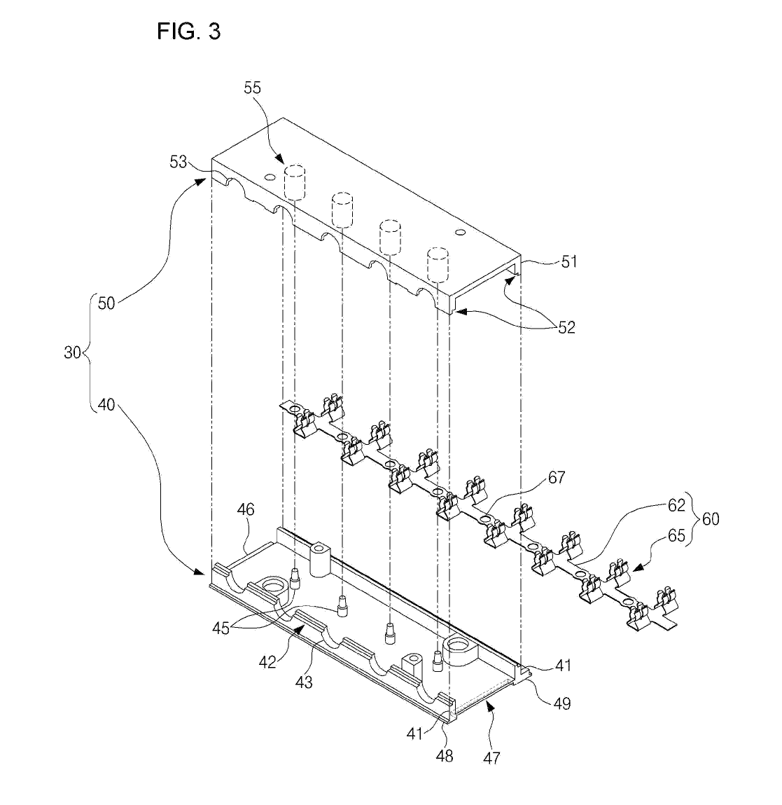

The external electrode holder 30 and the socket 60 are described below in detail with reference to FIG. 3.

FIG. 3 is an exploded perspective diagram illustrating the external electrode holder 30.

As illustrated in FIG. 3, the external electrode holder 30 includes a lower cover 40, and an upper cover 50 coupled to a top of the lower cover 40.

The lower cover 40 and the upper cover 50 are formed at a predetermined length to have sidewalls 41 and 51 of predetermined heights facing each other at left and right sides, respectively, and are opened at their front and rear ends.

Desirably, coupling surfaces of the sidewalls 41 and 51 are bent to cut off a leakage of an electric field to the external when the lower cover 40 and the upper cover 50 are coupled to each other.

That is, as illustrated, the sidewalls 41 and 51 have step parts 42 and 52 at their ends such that the step parts 42 and 52 can be shape-matched correspondingly to each other.

Semicircular relief grooves 43 and 53 of predetermined depths are provided at one-sidewalls 41 and 51 of the lower and upper covers 40 and 50 to face each other and provide a through-hole 56 (shown in FIG. 4) which the EEFL 21 passes through.

The semicircular relief grooves 43 and 53 are not limited to a semicircular shape, but may be of various shapes such as a rectangular shape and the like.

A guide part 48 of a predetermined height is protruded along a length direction from a lower end of one side of the lower cover 40. A guide part 49 is protruded from a front and rear end of a lower end of the other side of the lower cover.

At this time, the guide parts 48 and 49 may have step parts at their ends considering a structure of the fixing frame 10.

The guide parts 48 and 49 are sliding-coupled to a guiderail 15 (shown in FIG. 4) formed in the fixing frame 10 along a length direction. The guide parts 48 and 49 may be of various shapes according to a shape of the guide rail 15.

Accordingly, the lower cover 40 is sliding-coupled to the fixing frame 10 and thus, the external electrode holder 30 is fixed to the fixing frame 10. At this time, in case that the external electrode holder 30 is constructed in plural, the external electrode holders 30 can be sequentially sliding-coupled to the fixing frame.

Also, the external electrode holders 30 of a suitable length or suitable number can be sequentially sliding-coupled to the fixing frame 10 in consideration of the number of EEFLs 21 to be installed.

However, the external electrode holder 30 is not limited to sliding coupling, but may be screw-coupled to fix the lower cover 40 to the fixing frame 10.

A plurality of guide protrusions 45 are up-protruded and formed at regular intervals at an inner and lower surface of the lower cover 40.

The guide protrusions 45 are inserted into guide through-holes 67 provided in a terminal support 62 of the socket 60 described below, and have step parts at their tops.

A plurality of press protrusions 55 are protrude and formed at the upper cover 50 correspondingly to the guide protrusions 45 of the lower cover 40.

The press protrusions 55 are out-inserted to the guide protrusions 45. An insertion hole is provided in the press protrusion 55, and press-inserts the guide protrusion 45 such that the upper cover 50 is firmly fixed to the lower cover 40 and is not released from the lower cover 40.

The external electrode holders 30 constructed in plural can be shape-matched to each other at their connection parts (C) in a female-male structure.

That is, the external electrode holders 30 can be sequentially coupled to each other in a fitting manner by fitting a protrusion 46 into an insertion groove 47. The protrusion 46 is formed at a lower side of a front end of the lower cover 40. The insertion groove 47 is provided at a lower side of a rear end of the lower cover 40 to match with the protrusion 46.

Here, the connection part (C) of the external electrode holder 30 is not limited to the coupling of the protrusion 46 and insertion groove 47 of the lower cover 40, but the external electrode holder 30 may be coupled to each other using a protrusion 46 and an insertion groove 47 provided at the whole front and rear ends of the lower cover 40 and the upper cover 50.

The socket 60 includes the terminal support 62 and the terminals 65.

The terminal support 62 is formed to have a predetermined length correspondingly to the number of EEFLs 21. The terminals 65 are parts for out-inserting and coupling the external electrode 22 of the EEFL 21, and are elastically up-protruded and formed at regular intervals along a length direction of the terminal support 62.

The terminals 65 are formed in pair at both sides of the terminal support 62, respectively, and are elastically out-inserted to the external electrode 22 of the EEFL 21.

Accordingly, the socket 60 is parallel-coupled to the EEFLs 21 conductible with each other by coupling the external electrodes 22 of the EEFLs 21 to the terminals 65, respectively.

Coupling of the external electrode holder 30 is described below.

First, by out-inserting the guide through-hole 67 of the terminal support 62 to the guide protrusion 45 of the lower cover 40, the socket 60 is fixed to the lower cover 40. After that, the external electrode 22 of each EEFL 21 is press-inserted and fixed to the terminal 65 of the socket 60. Next, the upper cover 50 is coupled to a top of the lower cover 40.

At this time, the press protrusion 55 of the upper cover 50 is out-inserted to the guide protrusion 45 of the lower cover 40 and simultaneously, presses and fixes the terminal support 62 of the socket 60 at its front end.

Accordingly, the upper cover 50 is coupled to the lower cover 40 while pressing and fixing the socket 60.

The socket 60 coupled to the external electrode holder 30 is the same as a socket 160 coupled to an internal electrode holder 110 described below, but the terminals 65 can be arranged such that a space distance between the terminals 65 is half of a space distance between terminals 165 of the socket 160 installed in the internal electrode holder 110, in consideration of an addition of the EEFL 21 or a commonality to a different light panel.

A state in which the external electrode holder 30 is coupled to the fixing frame 10 is described below with reference to FIG. 4.

FIG. 4 is a sectional diagram illustrating the state in which the external electrode holder 30 is coupled to the fixing frame 10.

As illustrated in FIG. 4, the external electrode holder 30 is sliding-coupled to the fixing frame 10 with the upper cover 50 and the lower cover 40 coupled to each other. At this time, the guide parts 48 and 49 protruded and formed at the lower ends of the both sidewalls of the lower cover 40 are sliding-inserted and fixed to the guide rail 15 of the fixing frame 10.

The external electrode 22 of the EEFL 21 is inserted and fixing-supported by the pair of terminals 65 of the socket 60 provided within the external electrode holder 30. The socket 60 is fixed within the external electrode holder 30 by pressing the terminal support 62 using the press protrusion 55.

At this time, the socket 60 connects at its end with the stabilizer 70 through the power line 80.

A light emitting unit of the EEFL 21 is exposed to the external through the through-hole 56 of the external electrode holder 30.

The light reflective plate 5 is coupled to a lower part of the fixing frame 10 and reflects and irradiates light of the lighting unit 20 only to the front. The cover plate 6 is installed at a top of the light reflective plate 5.

The cover plate 6 supports a billboard installed in front. The cover plate 6 may be of material such as transparent acryl such that the lighting unit 20 can lighten the billboard without loss.

The light reflective plate 5 is inserted and fixed at its edge to a support groove 17 formed in the fixing frame 10. The light reflective plate 5 may be of a wooden panel such as a Medium Density Fibreboard (MDF).

The buffer part 13 can be installed at a top surface of the external electrode holder 30.

The buffer part 13 is press-inserted and installed at a top of the external electrode holder 30 inside the fixing frame 10, and prevents a vibration of the external electrode holder 30. The buffer part 13 is of a rectangular bar shape of a predetermined length, and may be installed in plural.

Accordingly, the buffer part 13 presses the top of the external electrode holder 30 and prevents the vibration of the external electrode holder 30.

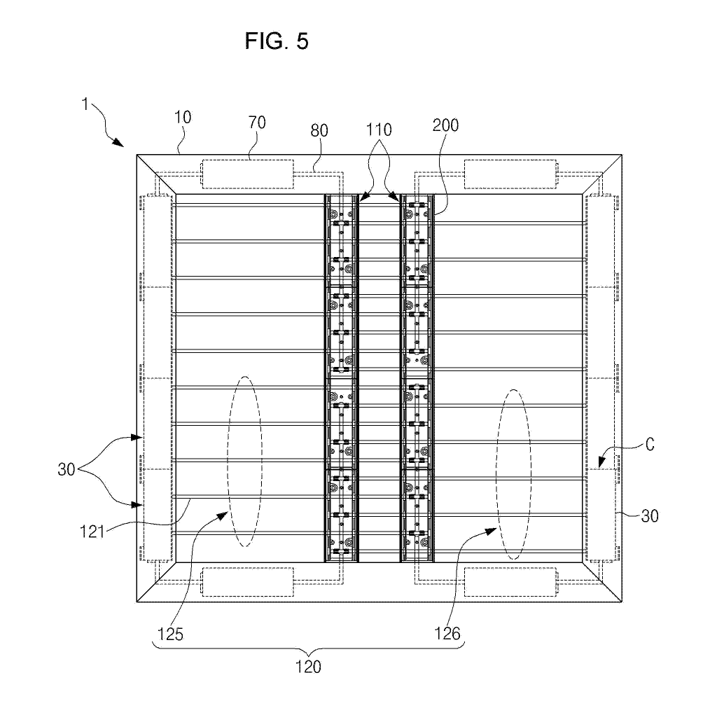

A high brightness light panel according to another exemplary embodiment of the present invention is described below with reference to FIGS. 5 to 7.

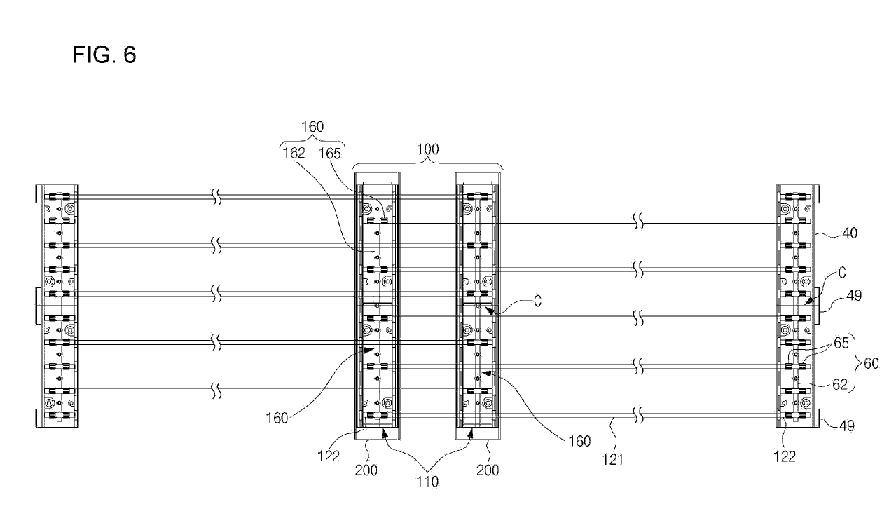

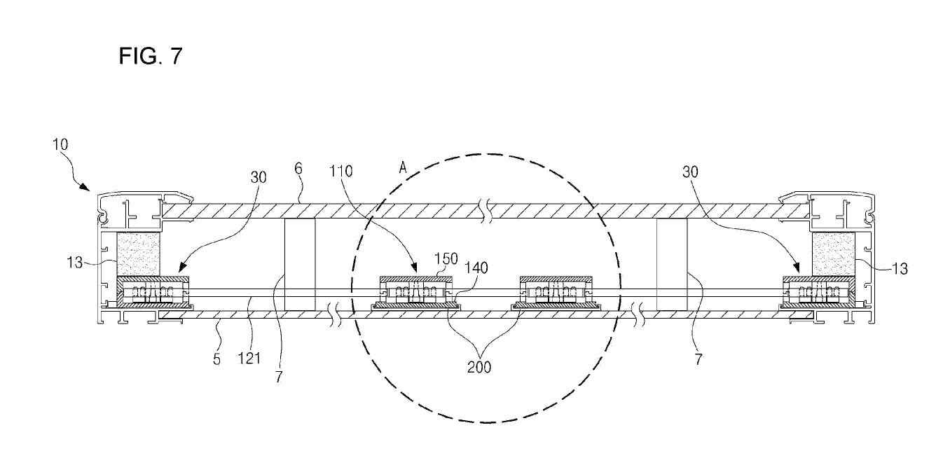

FIG. 5 is a plane diagram illustrating a high brightness light panel 1 according to another exemplary embodiment of the present invention. FIG. 6 is a partial plane diagram illustrating a lighting unit of the light panel of FIG. 5. FIG. 7 is a cross-sectional diagram illustrating the light panel of FIG. 5.

The light panel 1 of FIG. 5 is the same as the light panel of FIG. 1 excepting a construction of adding a connection means 100 and a support 7 to the light panel of FIG. 1 and thus, only the modified construction is described below.

The light panel of FIG. 5 includes a fixing frame 10, a light reflective plate 5, a lighting unit 120, the connection means 100, and an external electrode holder 30.

The lighting unit 120 includes unit lamp groups 125 and 126 in which at least one or more EEFLs 121 are spaced a predetermined distance apart and arranged. The lighting unit 120 is provided to connect and install a plurality of the unit lamp groups 125 and 126 in a transverse direction.

The connection means 100 connects EEFLs 121 with each other such that there is not a shadow spot in a connection part connecting the EEFLs 121 in a transverse direction. The connection means 100 is installed to alternately overlap and parallel-couple external electrodes 122 of the EEFLs 121 conductible with each other.

Accordingly, the connection means 100 includes a pair of internal electrode holders 110. The internal electrode holders 110 are spaced a predetermined distance apart and installed to be coupled to the external electrodes 122 of the plurality of EEFLs 121 provided in each of the unit lamp groups 125 and 126.

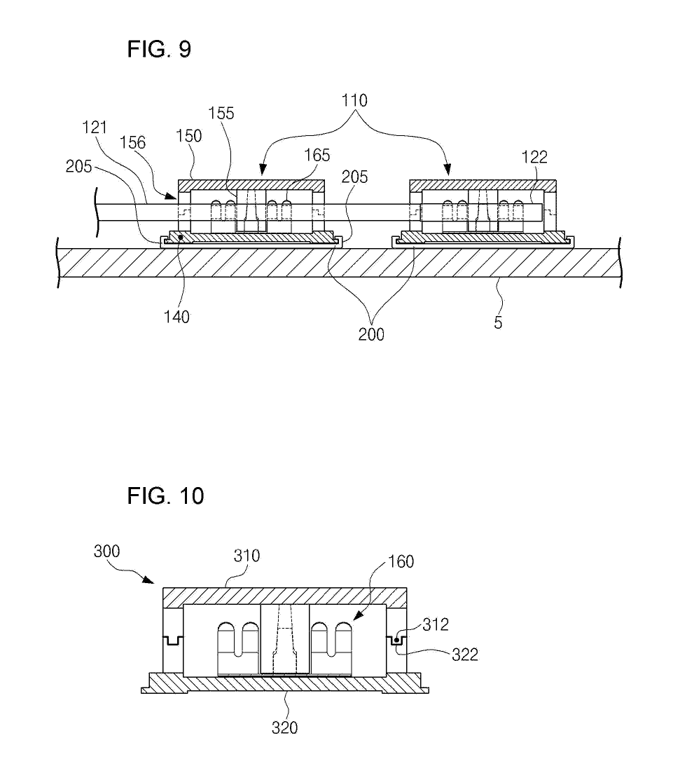

The internal electrode holders 110 are fixed to top surfaces of a pair of heat sinks 200 coupled to a center of the light reflective plate 5, respectively. Sockets 160 with a plurality of terminals 165 are provided within the internal electrode holders 110. A plurality of through-holes 156 (shown in FIG. 9) are provided in the internal electrode holders 110 such that the EEFLs 121 of the unit lamp groups 125 and 126 pass through.

At this time, as illustrated in FIG. 6, the sockets 160 are installed in the internal electrode holders 110, respectively, such that the terminals 165 are not positioned on the same line and are alternately arranged, so the EEFLs 121 can be alternately arranged and overlapped with each other.

Accordingly, the plurality of EEFLs 121 arranged in each of the unit lamp groups 125 and 126 are coupled in parallel to be conductible with each other and simultaneously are overlap-arranged by the connection means 100, thereby removing the shadow spot.

Also, like the external electrode holder 30, the internal electrode holder 110 can be constructed in plural in one socket 160.

Stabilizers 70 are insertion-installed at a top and bottom of the fixing frame 10. The stabilizers 70 connect by a power line 80 with the sockets 160 and 60 installed in the internal and external electrode holders 110 and 30.

The light reflective plate 5 is installed at a lower side of the fixing frame 10. The heat sink 200 is coupled to a center of the light reflective plate 5, and is installed in pair correspondingly to the pair of internal electrode holders 110 of the connection means 100.

The heat sink 200 rapidly emits out a heat generated by the external electrode 122 of the EEFL 121. The heat sink 200 is fixed to a front part of the light reflective plate 5 and is adhered to a rear surface of the internal electrode holder 110, thereby emitting the heat.

At this time, the heat sink 200 can be fixed to the light reflective plate 5 using a double-sided tape, an adhesive, or a screw. Desirably, the heat sinks 200 are grounded at both ends to the fixing frame 10 for the sake of electric discharge prevention.

At this time, the grounding can be achieved by screw-coupling to the fixing frame 10 using a ground bracket and the like.

The EEFL 121 passes through the internal electrode holder 110 of one side and then, the external electrode 122 is coupled to the terminal 165 of the socket 160 provided in the internal electrode holder 110 of the other side.

At this time, a space distance between the internal electrode holders 110 may be suitably selected considering a length of the external electrode 122 of the EEFL 121 and the efficiency of removal of the shadow spot.

A plurality of supports 7 are installed in the light reflective plate 5 to prevent deformation of the cover plate 6, sagging, etc. and support a bottom surface of the cover plate 6.

The supports 7 can be fixed to the light reflective plate 5 using an adhesive and the like, and may be installed in plural in various positions according to a size of the light panel 1.

Desirably, the support 7 is of material of transparent acryl and the like.

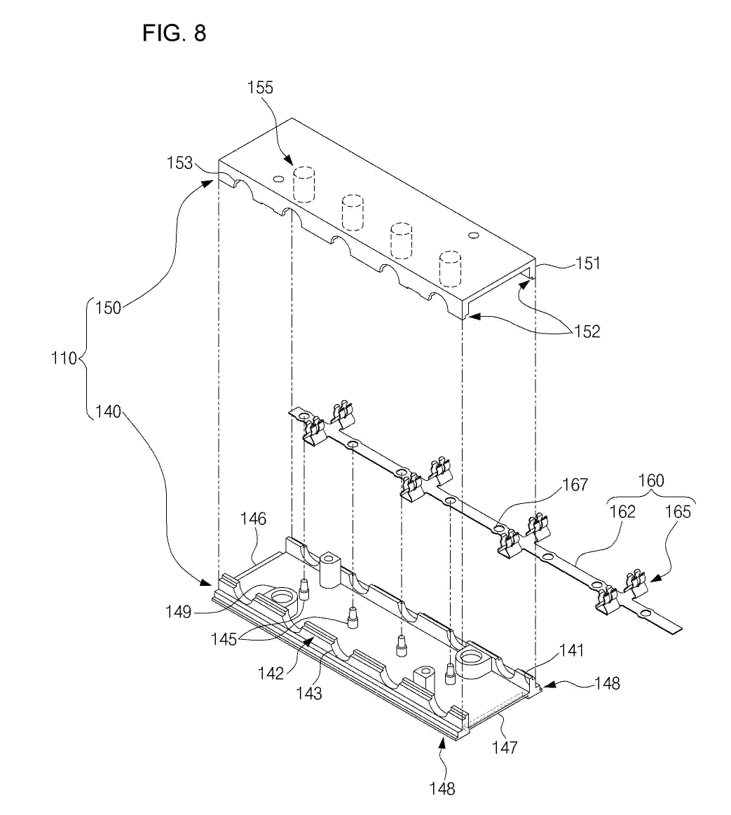

A structure of the internal electrode holder 110 of the connection means 100 is described below in detail with reference to FIGS. 8 and 9.

FIG. 8 is an exploded perspective diagram illustrating the internal electrode holder 110. FIG. 9 is a sectional diagram illustrating the internal electrode holder 110.

A lower cover 140 and an upper cover 150 of the internal electrode holder 110 are similar with the lower cover 40 and the upper cover 50 of the external electrode holder 30, respectively. A guide protrusion 145, a press protrusion 155, a protrusion 146, an insertion groove 147, and step parts 142 and 152 have the same constructions as those of the external electrode holder 30, but only a coupling structure of the lower cover 140 for coupling the internal electrode holder 110 to the heat sink 200 and the socket 160 is different and thus, only the different construction is described below.

As illustrated in FIG. 8, the internal electrode holder 110 is fixing-coupled to a front part of the light reflective plate 5 installed in the fixing frame 10. The internal electrode holder 110 includes the lower cover 140, and the upper cover 150 coupled to a top of the lower cover 140.

The upper cover 150 and the lower cover 140 are formed of transparent material such that light of the EEFL 25 is not interrupted.

The lower cover 140 and the upper cover 150 are formed at a predetermined length to have sidewalls 141 and 151 of predetermined heights facing each other at left and right sides, respectively, and are opened at their front and rear ends.

Like the external electrode holder 30, desirably, the internal electrode holder 110 have step parts 142 and 152 shape-matched to each other at ends of the sidewalls 141 and 151 of the lower cover 140 and the upper cover 150, thereby preventing a leakage of an electric field.

Relief grooves 143 and 153 of predetermined depths are provided at both sidewalls 141 and 151 of the lower and upper covers 140 and 150 to face each other and provide a through-hole 156 through which the EEFL 121 passes.

Guide ribs 148 of predetermined heights can be protruded along a length direction from lower ends of both side surfaces of the lower cover 140, respectively.

The guide ribs 148 are sliding-coupled to the heat sink 200 of the light reflective plate 5. The guide ribs 148 are slid and inserted to a guiderail 205 (shown in FIG. 9) installed in the heat sink 200, thereby fixing the internal electrode holder 110 to the heat sink 200.

Accordingly, in case that the internal electrode holder 110 is constructed in plural, the internal electrode holders 110 can be sequentially sliding-coupled and fixed to the heat sink 200.

However, the internal electrode holder 110 is not limited to the sliding coupling to the heat sink 200, but may be screw-coupled to the light reflective plate 5 or the heat sink 200 using a coupling hole 149 illustrated in FIG. 8.

As in the external electrode holder 30, a plurality of guide protrusions 145 and press protrusions 155 are protruded in corresponding positions from inner surfaces of the lower and upper covers 140 and 150

Like the external electrode holder 30, the internal electrode holders 110 can be shape-matched to each other at their connection parts (C) in a female-male structure.

That is, the internal electrode holders 110 can be sequentially coupled to each other in a fitting manner by fitting a protrusion 146 into an insertion groove 147. The protrusion 146 is formed at a lower part of a front end of the lower cover 140. The insertion groove 147 is provided in a lower part of a rear end of the lower cover 140.

The socket 60 includes the terminal support 162 and the terminals 165.

The terminal support 162 is formed to have a predetermined length correspondingly to the number of EEFLs 121. A pair of the terminals 165 are up-protruded at regular intervals along a length direction, so the external electrodes 122 of a plurality of EEFLs 121 are coupled in parallel with each other.

Also, a space distance between the terminals 165 is large enough not to interfere with the EEFL 121 of the other unit lamp groups 125 or 126.

Accordingly, the sockets 160 installed in each internal electrode holder 110 allow the EEFLs 121 to overlap at their ends with each other and simultaneously, parallel-couples the EEFLs 121 conductible with each other by each unit lamp group 125 or 126.

Like the external electrode holder 30, the internal electrode holder 110 is coupled by fixing the socket 160 to the lower cover 140, press-inserting and fixing the external electrode 122 of each EEFL 121 to the terminal 165 of the socket 160, and then coupling the upper cover 150 to the top of the lower cover 140.

At this time, the sockets 160 installed in the internal electrode holders 110 to face each other are fixed to the guide protrusion 145 of the lower cover 140 such that the terminals 165 are not positioned on the same line and can be alternately arranged.

The lower cover 140 is fixed by inserting the guide ribs 148 of the lower ends of both sides of the lower cover 140 into the guide rail 205 of the heat sink 200. The upper cover 150 is fixed by press-inserting the guide protrusion 145 of the lower cover 140 to the press protrusion 155.

At this time, the press protrusion 155 presses the terminal support 162 at its front end, thereby fixing the socket 160.

The EEFL 121 passes through the internal electrode holder 110 of one side and then, the external electrode 122 is coupled to the terminal 165 of the socket 160 provided in the internal electrode holder 110 of the other side.

At this time, a space distance between the internal electrode holders 110 may be suitably selected considering a length of the external electrode 122 of the EEFL 121 and the efficiency of removal of the shadow spot.

An internal electrode holder 300 according to another exemplary embodiment of the present invention is described below with reference to FIG. 10.

FIG. 10 is a sectional diagram illustrating the internal electrode holder 300 according to another exemplary embodiment of the present invention. A construction of the internal electrode holder 300 is the same as that of the above exemplary embodiment excepting a coupling surface between an upper cover 310 and a lower cover 320 and thus, only a modified construction is described below.

As illustrated in FIG. 10, a protrusion rib 312 of a predetermined height is formed along a length direction at a center of a sidewall of the upper cover 310 of the internal electrode holder 300. An insertion hole 322 is provided along the length direction at a center of an upper end of a sidewall of the lower cover 320. So, the protrusion rib 312 can be inserted into the insertion hole 310.

Accordingly, a coupling surface is bending-formed between the upper cover 310 and the lower cover 320 of the internal electrode holder 300, thereby effectively preventing an electric field generated by the external electrode 122 of the EEFL 121 from being emitted to the external.

Another exemplary embodiment of the coupling surface of the internal electrode holder 300 of FIG. 10 may be identically applicable to the external electrode holder 30.

Accordingly, the present invention can safely, simply, and conveniently realize a definite high-brightness light panel 1 by arranging and installing a plurality of EEFLs 21 and 121 of a high brightness and a stable operation characteristic. The present invention can remove a shadow spot and remarkably improve product reliability by providing internal and external electrode holders 110 and 310 of an excellent insulation characteristic. In addition, by modularizing a plurality of EEFLs 21 and 121, installation and uninstallation is easy and the large-sizing of the light panel 1 is easy.

As described above, the present invention has the following effects. The first is that, due to excellent extensibility, a large-area light panel of a high brightness can be realized and product quality can be remarkably improved through removal of a shadow spot generated in a connection part for connecting EEFLs. The second is that, by modularizing EEFLs as a plurality of unit lamp groups, installation and uninstallation is simple and convenient, and maintenance is easy. The third is that, by effectively preventing a user's safety accident due to a high heat, a high voltage, etc., product reliability can be improved.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A high brightness light panel comprising:
a fixing frame forming an outer frame;
a light reflective plate installed in the fixing frame;
a lighting unit having at least one or more External Electrode Fluorescent Lamps (EEFLs) spaced apart and arranged in parallel and forming one unit lamp group; and
an external electrode holder sliding-inserted and installed along a length direction of the fixing frame, and having sockets installed therein and fixing-supporting external electrodes of the EEFLs such that the external electrodes can be coupled in parallel to be conductible with each other.

2. The light panel of claim 1, wherein the lighting unit has a plurality of the unit lamp groups connected and installed,
wherein a connection part connects the unit lamp groups to each other and is arranged such that the EEFLs overlap with each other at their ends, and
wherein the connection part has a connection means for installing and coupling the sockets to the external electrodes of the EEFLs.

3. The light panel of claim 2, wherein a heat sink is installed in the light reflective plate, and supports a rear surface of the connection means and simultaneously emits a heat outside.

4. The light panel of claim 3, wherein the heat sink is grounded at both ends to the fixing frame for electric discharge cut-off.

5. The light panel of claim 3, wherein the connection means comprises a pair of the internal electrode holders having the sockets installed therein, and
wherein the internal electrode holder has a plurality of through-holes through which EEFLs of the other adjacent unit lamp group can pass.

6. The light panel of claim 5, wherein the heat sink is provided in pair correspondingly to the pair of internal electrode holders.

7. The light panel of claim 5, wherein the internal electrode holder comprises a lower cover and an upper cover to install the sockets therein, and the lower cover and the upper cover have relief grooves of predetermined depths facing each other at their both sidewalls to provide the through-holes.

8. The light panel of claim 7, wherein the external electrode holder comprises a lower cover and an upper cover to install the sockets therein, and the lower cover and the upper cover have relief grooves of predetermined depths facing each other at their both sidewalls to provide the through-holes that the EEFLs pass through.

9. The light panel of claim 8, wherein the both sidewalls of the lower cover and the upper cover of each of the internal and external electrode holders are bent and shape-matched at their coupling surfaces to cut off a leakage of an electric field.

10. The light panel of claim 9, wherein an insertion groove is provided along a length direction at a center of any one sidewall of the lower cover or the upper cover, and a protrusion rib is formed at an end of the other sidewall to be inserted into the insertion groove.

11. The light panel of claim 8, wherein the socket of the internal or external electrode holder comprises:
a terminal support of a predetermined length coupled to a center of the lower cover; and
a plurality of terminals up-protruded at regular intervals along a length direction of the terminal support and out-inserted to the external electrode of the EEFL.

12. The light panel of claim 11, wherein the lower cover has guide protrusions up-protruding and inserted into a plurality of guide through-holes that are through-formed in the terminal support, and
wherein the upper cover has press protrusions out-inserted to the guide protrusions and press-fixing the terminal support.

13. The light panel of claim 8, wherein the internal and external electrode holders are constructed in plural, and have connection parts shape-matched to each other in a female-male structure.

14. The light panel of claim 13, wherein the lower cover of the internal electrode holder has guide ribs protruded along a length direction at lower ends of its both side surfaces and sliding-inserted to a guide rail formed in the heat sink.

15. The light panel of claim 13, wherein the lower cover of the external electrode holder has a guide part protruded at a predetermined height at lower ends of its both side surfaces and insertion-coupled to a guide rail formed in an inner bottom surface of the fixing frame.

16. The light panel of claim 13, wherein the lower cover of the internal or external electrode holder has a protrusion at its front end, and has an insertion groove provided at its rear end and inserting a protrusion of an adjacent another lower cover.

17. The light panel of claim 1, further comprising an anti-vibration buffer part between a top surface of the external electrode holder and an inner surface of the fixing frame.

18. The light panel of claim 5, further comprising:
a stabilizer connecting to the sockets of the internal and external electrode holders and insertion-coupled to the fixing frame; and
an insulation tube out-inserted to the stabilizer and a socket connecting power line.

19. The light panel of claim 2, further comprising:
a cover plate of transparent material coupled to a top of the fixing frame; and
a plurality of supports installed in the light reflective plate and supporting the cover plate.
